(19) United States
(12) Patent Application Publication
(10) Pub. No.: US 2026/0254675 A1
(43) Pub. Date: Aug. 27, 2026

(54) ETHERNET COLLISION DETECTION

(71) Applicant: Infineon Technologies AG, Neubiberg (DE)

(72) Inventors: Longli Yu, Taufkirchen (DE); Tobias Islinger, Höhenkirchen-Siegertsbrunn (DE); Vivin Richards Allimuthu Elavarasu, Bayern (DE)

(21) Appl. No.: 19/546,579

(22) Filed: Feb. 23, 2026

(30) Foreign Application Priority Data
Feb. 27, 2025 (DE) 10 2025 107 435.6

(51) Int. Cl. H04L 12/40; H04L 12/413; H04L 12/54

(52) U.S. Cl. CPC H04L 12/40084; H04L 12/413; H04L 12/5601; H04L 2012/5679; H04L 2012/5681

(57) ABSTRACT

A digital PHY transmits a signal comprising a plurality of symbols to an Ethernet transceiver for transmission on Ethernet line. A copy of the signal is stored in buffer. A collision detector compares the signals received on RX line with those stored in the buffer and signals a collision when the received symbols do not match the transmitted symbols, or when the bits of the received symbols do not match corresponding bits of the transmitted symbols. A gate arrangement may allow for configuration to different scenarios with different devices connected to Ethernet line.

### REFERENCE TO RELATED APPLICATION

This Application claims the benefit of German Application number 102025107 435.6, filed on Feb. 27, 2025, the contents of which are hereby incorporated by reference in their entirety.

### FIELD OF THE INVENTION

There is described a collision detection system for Ethernet communication, a device implementing such a collision detection system and a method of collision detection.

### BACKGROUND OF THE INVENTION

Many different Ethernet communication standards are defined by the IEEE, for different applications, transmission distances and approaches. Conventional Ethernet uses four wires but two wire Ethernet standards such as 10 Base T1L and 10 Base T1S are also defined. The latter standard also allows multi-drop Ethernet, in other words an Ethernet connection with more than two devices connected to the Ethernet wiring.

In order to allow multi-drop communication, there needs to be a means provided for avoiding collisions on the network, in other words for avoiding multiple devices from simultaneously trying to transmit on the network, and for dealing with collisions should they occur. The 10 Base T1S IEEE standard defines such a system, which is referred to as physical layer collision avoidance, PLCA.

In the 10 base T1S PLCA as defined by IEEE standard 802.3cg each device connected to a link has a unique integer ID from 0 upwards, so for N devices each has a unique ID from 0 to (N-1). A beacon signal transmitted by device 0 aligns the time for devices connected to the link. Each device then independently counts up from 0. When the count reaches the device ID, then if the device has data to transmit it asserts this and transmits data; while data is being transmitted the count is paused in each device. After the data is transmitted, the device signals this and the count continues. If the device has no data to transmit when the count reaches the device ID, the count simply continues.

In such a system it is important to detect a collision, i.e. to detect the case that multiple devices transmit, so that such cases can be properly dealt with.

Referring to FIG. 1, in the 10 Base T1S system as proposed by IEEE standard 802.3cg an operating host 100 implements a data link layer including in particular a media access control MAC 102. A physical layer device, PHY, 110 includes a physical coding sublayer PCS 114, a physical medium attachment sublayer PMA 116 and an autonegotiation AN block 118 which is in turn connected to the two wire Ethernet medium 120. A media independent interface MII bus 104 connects the MAC 102 to the PCS 114. A Physical layer collision avoidance PLCA block 112 is provided connected between the MAC 102 and PCS 114 connected to both by the MII bus 104.

The 802.3cg standard defines the PLCA 112 to be in the PHY 110 and is arranged to communicate with a suitable host having a MAC layer, for example a microcontroller or other device, using a conventional MII bus 104. However, the MII bus defines a relatively high number of communication lines which increases costs in some applications, for example automotive.

Accordingly, referring to FIG. 2, the Open Alliance, OA, TC14 subgroup transceiver interface document with the specification ““10BASE-T1S PMD Transceiver Interface” specifies an alternative arrangement with a host 200, a 10Base T1S PMD transceiver 210 and an open alliance three wire link 220 connecting the host 200 with the PMD transceiver 210 using a PMD transceiver interface 222 in the host 200. In other words, this alternative arrangement requires only three wires. The three wire link 220 includes a transmission TX line 223 for transmitting data from the PMD transceiver interface 222 to the PMD transceiver 210 from where it is transmitted to the Ethernet line 120, a receiver RX line 224 for receiving data from the PMD transceiver 210 and transmitting it to the PMD transceiver interface 222 in the host, and an Energy Detect, ED line 226 which transmits an indication from the PMD transceiver 210 to the PMD transceiver interface 222 in the host, the signal being generated using a window comparator which indicates whether or not the differential voltage on medium 120 is contained within a specific amplitude band centered on zero.

The PLCA 230 may be provided in host 200 and the PCS/PMA layer 232 may also be provided in host 200.

As indicated above, collision detection is an important feature of such networks. Both the IEEE 802.3cg standard and the OA standard allows collision detection functionality in a multiple different layers, namely PLCA layer, PCS layer and PMD layer. How these different collision detection mechanisms operate and in particular how they interact is left out of scope of the standards. In other words, it is not defined how to deal with the fact that collision detection could occur at different levels in the stack. Different collision detection mechanisms can have different impacts and result in interoperability issues where different choices are made in different devices.

There is accordingly a need for a robust collision detection method.

### SUMMARY OF INVENTION

In an aspect there is disclosed an Ethernet digital physical layer, PHY, including a physical medium attachment, PMA, layer transmitter being arranged to transmit data in the form of sequential symbols towards an Ethernet line; a physical coding sublayer, PCS, transmitter having an output connected to an input of the PMA layer transmitter, a PMA layer receiver being arranged to receive data as a sequence of symbols from the Ethernet line; a PCS receiver having an input connected to the output of the PMA layer receiver; a collision detection system including a buffer, the buffer being connected to the output of the PCS transmitter to store the symbols transmitted by the PCS transmitter, and a collision detector having an input connected to the output of the PMA layer receiver and an input connected to the buffer, the collision detector being arranged to compare, when the Ethernet digital PHY is in a transmission state, the symbols received from the PMA layer receiver with those stored in the buffer, and to signal a collision if the symbols do not match.

In another aspect there is disclosed a system including a digital PHY as set out above, an Ethernet MAC connected to the PLCA; and an Ethernet transceiver connected to the three wire connection and to an Ethernet line.

There is also disclosed a method of operating such a system including transmitting a signal comprising a plurality of symbols from the digital PHY to the Ethernet transceiver; transmitting the signal back from the Ethernet transceiver to the digital PHY as received signals; and signaling a collision when the received symbols do not match the transmitted symbols, or when the bits of the received symbols do not match the corresponding bits of the transmitted symbols.

### BRIEF DESCRIPTION OF THE DRAWINGS

Examples of the invention will now be described, purely by way of example, with reference to the accompanying drawings, in which:

FIG. 1 illustrates a 10 Base T1S approach according to an IEEE standard.

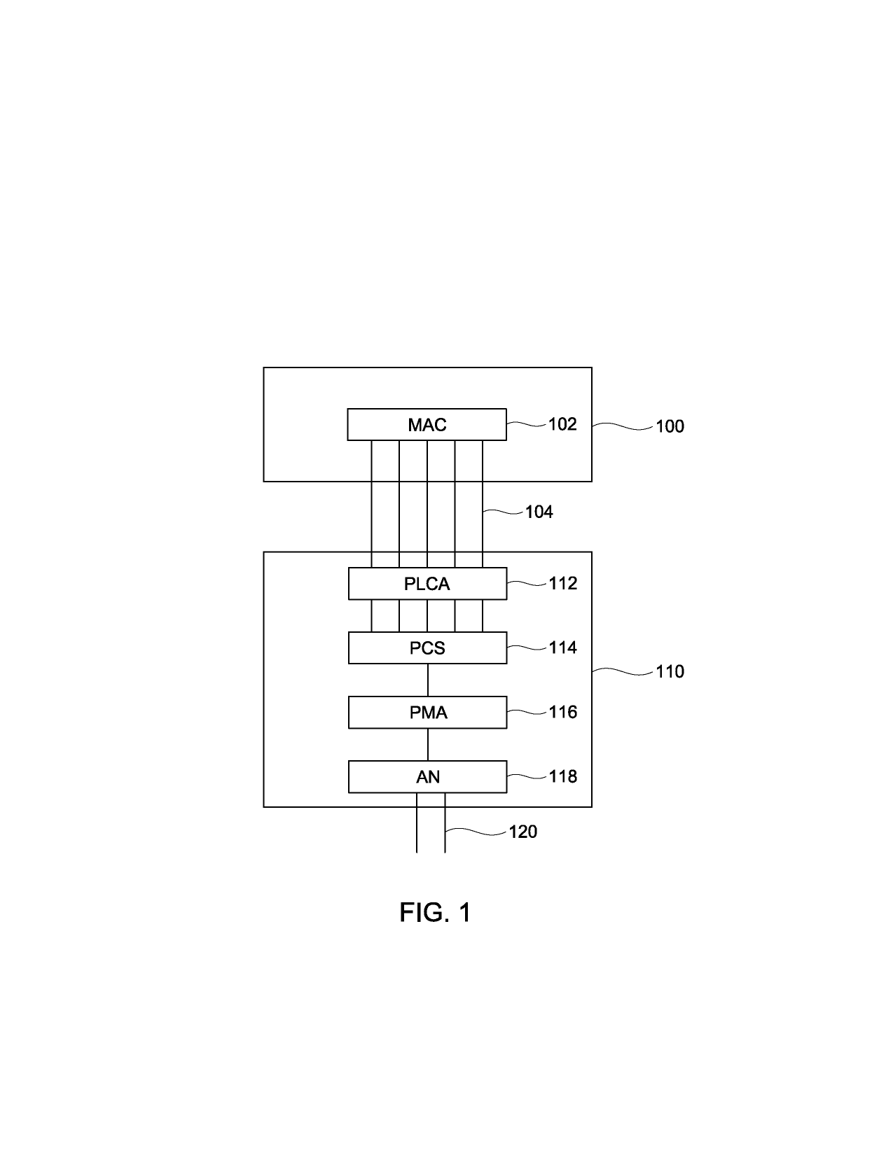

FIG. 2 illustrates a 10 Base T1S approach according to an OA standard.

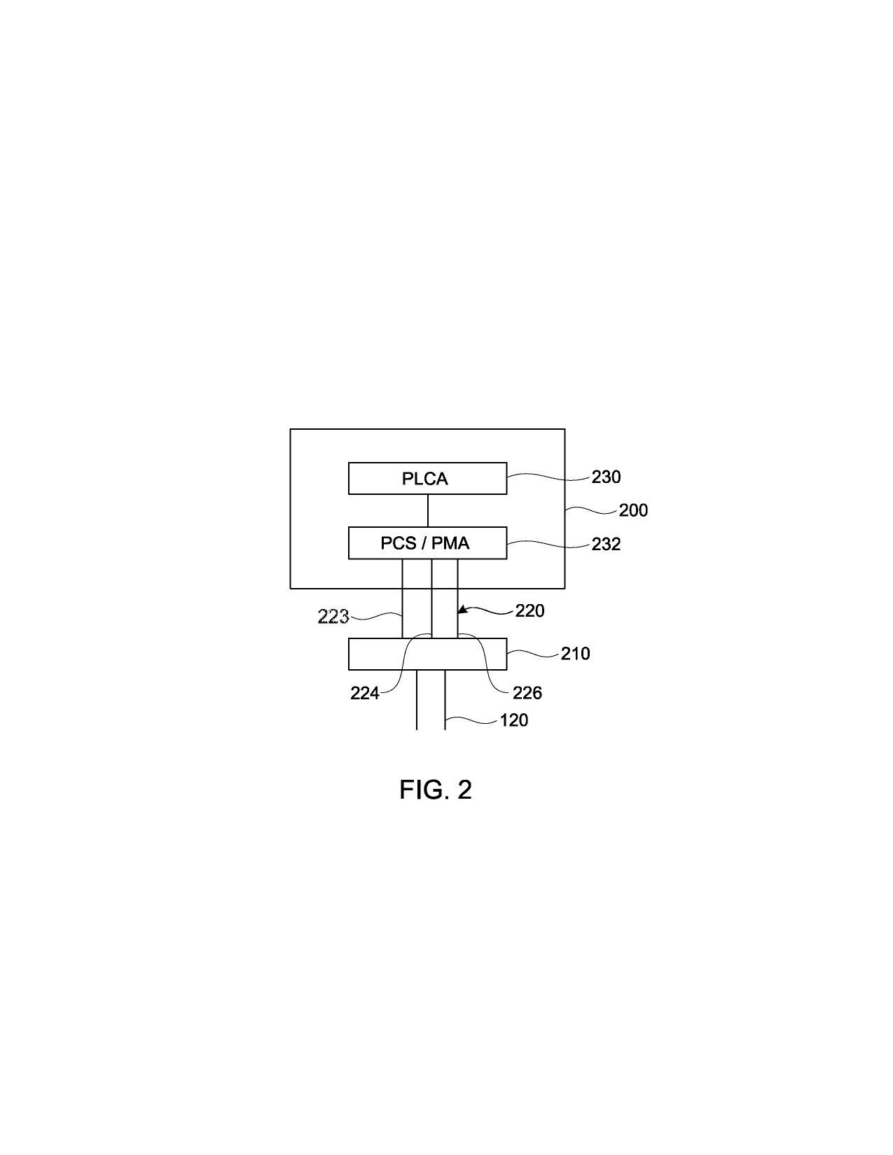

FIG. 3 illustrates a digital PHY connected to an Ethernet line through a transceiver.

### DETAILED DESCRIPTION

An example of the disclosure will be presented, purely by way of example.

It has been noted that the simple idea of detecting a collision by checking if signals arrive at a receiver terminal RX during transmission on a transmission terminal TX of a host having a three wire link according to the open alliance standard does not work in practice. This is because some implementations of 10 Base T1S transceivers sample the line and reflect received transmissions back to the host. In such cases, data transmitted on the TX terminal will be reflected back to the RX terminal of the PMD layer whether or not a collision occurs.

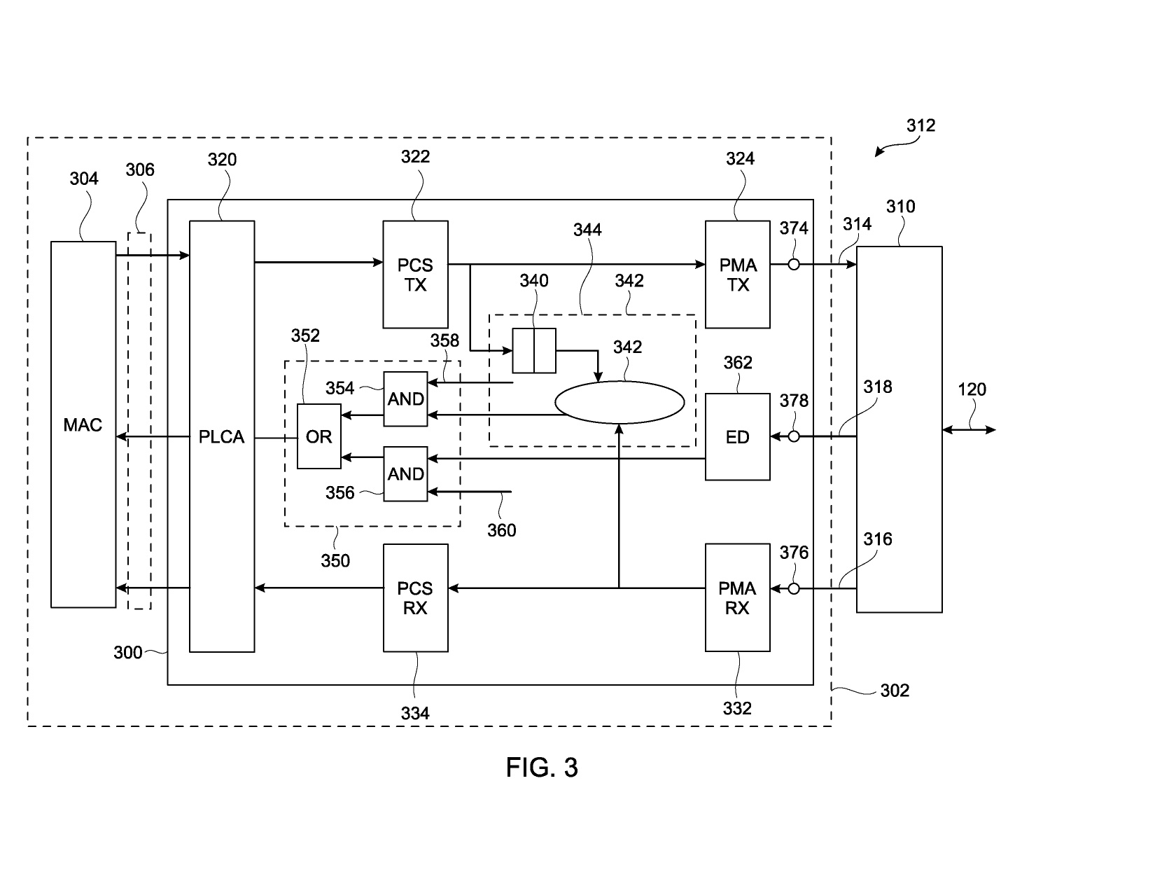

Referring to FIG. 3, a digital PHY 300 embedded in host 302 is provided. In the example of FIG. 3, the host 302 is a microcontroller; in the alternative the host may be any device where the provision of an Ethernet link is of use.

The host 302 includes an Ethernet MAC 304 in communication with the digital PHY using an MII bus 306. A separate transceiver 310 is provided connected to the host 302 using a three wire link 312 having a TX line 314, a RX line 316 and an ED line 318, in the example being according to the open alliance standard. The host 302 is provided with a three wire terminal including a TX output terminal 374 for connection to TX line 314, an RX input terminal 376 for connection to RX line 316 and an ED input terminal 378 for connection to ED line 318.

In use, the transceiver 310 is connected to two-wire Ethernet link 120.

In the above approach, both MAC 304 and digital PHY 300 are provided in host 302. In an alternative approach, the digital PHY 300 may be provided as stand-alone silicon, connected to a host using an external MII bus. Alternatively or additionally, the transceiver 310 may be implemented on the same silicon as the digital PHY 300.

A PLCA 320 is provided connected to MII bus 306 at both input and output sides. Note, in this way the PLCA may be switched out of action in case the PLCA 320 is not required, for example when Ethernet medium 120 is connected only to two devices and which therefore can operate in half-duplex mode.

A PCS transmitter 322 has its input connected to the MAC 304 and PLCA 320 through the MII bus 306, and an output connected to PMA transmitter 324. The output of PMA transmitter 324 is connected to TX output terminal 374 for connection in turn to TX line 314 for transmitting data from the host to the transceiver 310 and then onwards to Ethernet link 120.

A PMA receiver 332 has its input connected to RX input terminal 376 for receiving signals from the transceiver 310, and its output connected to the input of PCS receiver 334. The output of the PCS receiver 334 is connected to the MII bus 306 and through the MII bus 306 to PLCA 320 and MAC 304.

The output of the PCS transmitter 322 is also connected to buffer 340, in the example a FIFO buffer with a buffer size of 2 to 5 symbols. In the example, each symbol is a 5 bit transmission symbol defined by IEEE 302.3cg after 4b5b encoding (4 data bits encoded as 5 bits). Those skilled in the art will realize that alternative symbol sizes may be used.

The buffer 340 is also connected to collision detector 342 which has one input connected to buffer 340 and one input connected to the output of PMA receiver 332. The collision detector 342 may be implemented in hardware, such as a comparator or series of comparators or combinations of logical gates.

The buffer 340 and collision detector 342 make up part of collision detection system 344.

There is further provided a gate arrangement 350 comprising in the example an OR gate 352 with inputs connected to the output of PCS AND gate 354 and the output of PMD AND gate 356. The PCS AND gate 354 has one input connected to a PCS Collision enable line 358 and the other input to the output of the collision detector 342. The PMD AND gate 356 has one input connected to PMD collision enable line 360 and one input connected to the output of ED filter block 362. The input of ED filter block 362 is connected to ED terminal 378 for connection through ED line 318 to the output of the transceiver 310. It will be appreciated that such gate arrangements may be provided with different arrangements of gates, for example NAND gates, NOR gates as well as AND gates, OR gates and/or inverters. Such functionality may also be delivered in alternative approaches.

In use, the described system operates by comparing the symbols received on the RX line 316 with those transmitted on TX line 314. In the event of a collision, the received signals will not match the transmission symbols. The transceiver 310 is arranged to transmit signals for transmission received over TX line 314 back on RX line 316.

The collision detector 342 may for example signal a collision by asserting its output to PCS AND gate 354 when one of the following conditions applies.

The first condition is the condition that the received RX symbol does not correspond to the TX symbol at the top of the buffer 340. In this case, after the comparison the TX symbol at the top of the buffer is removed after the comparison.

A second condition which may be used as an alternative to the first condition is the condition that the RX data bit does not correspond to the TX data bit at the top of the buffer. In this alternative case, only the first TX data bit is removed after the comparison. Thus, in this case, the comparison is bit by bit. Note the digital PHY may be arranged to selectably use the first condition or the second condition.

In either bit-wise or symbol wise comparison modes, the collision detector 342 may also signal a collision in a third condition when the buffer 340 fills; this may be a symptom of a collision on the line.

A fourth condition that may also result in a collision being signaled is the condition that no RX symbol or bit is received after a predetermined period and if the buffer 340 is not empty. This allows the detection of a collision only of the last symbol of a transmission. For the predetermined time, a time of at least 2MII clock cycles, up to for example at least 4 MII clock cycles may be used. Using a standard MII arrangement this corresponds to 800 ns for the predetermined period. To allow a safety buffer, a longer predetermined period may be used, for example in the range 800 ns to 2000 ns.

The OA standard defines the maximum propagation delay through the transmission TX side as 50ns and through the receive RX side as 80 ns. The two-bit transmission time is 160ns, which means that the buffer size can be very small, namely two 5 bit symbols, which includes 10 bits and which have a total 800 ns transmission time. This means that a collision can be detected within this 800ns time.

In the alternative arrangement in which the second condition is used and the collision detector compares the individual bits, not the symbols as a whole, the detection can be made in the transmission time for three bits, namely 240ns.

In both alternatives the detection time is much better than the required time of 4500 ns.

Note that some symbols transmitted through the PCS transmitter block 322 and PMA transmitter block 324 to transceiver 310 are not symbols for transmission but symbols used to control transceiver 310. These symbols are not transmitted down line 120 and also reflected back and therefore should not be used for detecting a collision.

In the example illustrated, the PCS collision enable signal line 358 is only asserted when symbols for transmission, not control signals, are being transmitted. Thus, in this case PCS AND gate 354 filters out detections during control signal transmission. In an alternative or additional arrangement, such symbols can be filtered out and not stored in buffer 340.

For robustness, the buffer 340 is cleared when entering a transmission state. While not essential, this avoids false positive collisions being detected as a result of previous transmissions not being cleanly terminated.

Note that the ED line can also report a failure or collision condition. In the example, OR gate 352 effectively reports a collision either when collision detection system 344 detects an error or when the output of ED filter block 362 outputs a collision condition. Note that PMD AND gate 356 and PMD collision enable line 360 are used in a similar manner to the PCS AND gate 354 and PCS collision enable line 358 to prevent the output of ED filter block 362 being input to OR gate 352 when PMD collision enable line 360 is not asserted; this ensures that the signal on ED line 318 is not transmitted further when the digital PHY 300 or transceiver 310 is not in an active state. Thus, depending on the state of PCS collision enable line 358 and PMD collision enable line 360 collision detection by the collision detector 344, ED filter 362, neither or both may be activated.

By providing collision detection in host 302 the need for collision detection in the transceiver 310 may be avoided. This is of some benefit as many transceiver designs are simple and subject to tight cost constraints. Nevertheless, if the transceiver 310 provides full collision detection PCS collision enable line 358 may be permanently dis-asserted and PMD collision enable line 360 permanently asserted. Such assertions may be programmed into registers, for example during a boot process booting up the host 302.

This flexibility allows for the configuration of the digital PHY in different environments and with different transceivers. This in turn allows the device to be operated together with hardware operating in a different way by simply adapting the tests for activating the collision enable lines 358, 360 without requiring different hardware. In spite of the simplicity, the collision detector 344 can be implemented without excessive use of silicon area.

Although specific embodiments/examples/aspects have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

For example, although the arrangement above proposes a gate arrangement 350 with an OR gate and two AND gates, those skilled in the art will realize that alternative gate arrangements may be used, for example an arrangement simply using NAND gates.

In a first example, there is a Ethernet digital physical layer, PHY, including a physical medium attachment, PMA, layer transmitter being arranged to transmit data in the form of sequential symbols towards an Ethernet line ; a physical coding sublayer, PCS, transmitter having an output connected to an input of the PMA layer transmitter, a PMA layer receiver being arranged to receive data as a sequence of symbols from the Ethernet line; a PCS receiver having an input connected to the output of the PMA layer receiver; a collision detection system comprising a buffer, the buffer being connected to the output of the PCS transmitter to store the symbols transmitted by the PCS transmitter, and a collision detector having an input connected to the output of the PMA layer receiver and an input connected to the buffer, the collision detector being arranged to compare, when the Ethernet digital PHY is in a transmission state, the symbols received from the PMA layer receiver with those stored in the buffer, and to signal a collision if the symbols do not match.

The digital PHY according to claim 1 may further include a three wire terminal for connection to a transceiver.

The three wire terminal may include a TX output connected to the PMA layer transmitter, an RX input connected to the PMA layer receiver and an ED, Energy Detect, input.

The digital PHY may further comprise a gate arrangement having a collision detection output, one input connected to the output of the collision detector and one input connected to the ED input, so that the collision detection output reports a collision when detected by the collision detector or when reported by the transceiver through the ED input.

The digital PHY may further include a PCS collision enable line and a PMA collision enable line, wherein the gate arrangement is arranged to only report a collision on the collision detection output when the PCS collision enable line is asserted and the collision detector detects a collision, or when the PMA collision enable line is asserted and the ED input is asserted.

The digital PHY may further include a Physical Layer Collision Avoidance, PLCA, block, having an output connected to the PCS transmitter, an input connected to the PCS receiver, and an input connected to the output of the gate arrangement.

The digital PHY may be arranged to clear the buffer upon entering a transmission state.

The digital PHY may be arranged to suppress reporting of a collision when the symbols are configuration data.

The digital PHY may be arranged to remove each symbol from the buffer when it matches a received symbol, and the collision detector is arranged to report a collision if the buffer fills.

The collision detector may be arranged to report a collision if the buffer is not empty and no symbol is received by the PMA layer receiver in a predetermined time.

The size of the buffer may be less than 10 symbols.

There is also described a system including a digital PHY as set out above, an Ethernet MAC connected to the PLCA; and an Ethernet transceiver connected to the three wire connection and to an Ethernet line.

There is also described a method of operating such a system including transmitting a signal comprising a plurality of symbols from the digital PHY to the Ethernet transceiver; transmitting the signal back from the Ethernet transceiver to the digital PHY as received signals; and signaling a collision when the received symbols do not match the transmitted symbols, or when the bits of the received symbols do not match the corresponding bits of the transmitted symbols.

It should be noted that the examples as outlined in the present document may be used stand-alone or in combination with the other methods and systems disclosed in this document. In addition, the features outlined in the context of an apparatus are also applicable to a corresponding method, and vice versa. Furthermore, all aspects of the methods and apparatus outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

1. An Ethernet digital physical layer (PHY) comprising:
a physical medium attachment (PMA) layer transmitter being arranged to transmit data in the form of sequential symbols towards an Ethernet line;
a physical coding sublayer (PCS) transmitter having an output connected to an input of the PMA layer transmitter;
a PMA layer receiver being arranged to receive data as a sequence of symbols from the Ethernet line;
a PCS receiver having an input connected to the output of the PMA layer receiver;
a collision detection system comprising a buffer, the buffer being connected to the output of the PCS transmitter to store the symbols transmitted by the PCS transmitter; and
a collision detector having an input connected to the output of the PMA layer receiver and an input connected to the buffer, the collision detector being arranged to compare, when the Ethernet digital PHY is in a transmission state, the symbols received from the PMA layer receiver with those stored in the buffer, and to signal a collision if the symbols do not match.

2. The Ethernet digital PHY of claim 1, further comprising a three wire terminal for connection to a transceiver, the three wire terminal comprising:
a TX output connected to the PMA layer transmitter,
an RX input connected to the PMA layer receiver and
an ED, Energy Detect, input; and
wherein the digital PHY further comprises a gate arrangement having a collision detection output, one input connected to the output of the collision detector and one input connected to the ED input, so that the collision detection output reports a collision when detected by the collision detector or when reported by the transceiver through the ED input.

3. The Ethernet digital PHY of claim 2, further comprising:
a PCS collision enable line, and
a PMA collision enable line,
wherein the gate arrangement is arranged to only report a collision on the collision detection output when the PCS collision enable line is asserted and the collision detector detects a collision, or
when the PMA collision enable line is asserted and the ED input is asserted.

4. The Ethernet digital PHY of claim 2, further comprising a Physical Layer Collision Avoidance (PLCA) block, having an output connected to the PCS transmitter, an input connected to the PCS receiver, and an input connected to the output of the gate arrangement.

5. The Ethernet digital PHY of claim 1, wherein the digital PHY is arranged to clear the buffer upon entering a transmission state.

6. The Ethernet digital PHY of claim 1, arranged to suppress reporting of a collision when the symbols are configuration data.

7. The Ethernet digital PHY of claim 1, arranged to remove each symbol from the buffer when it matches a received symbol, wherein the collision detector is arranged to report a collision if the buffer fills.

8. The Ethernet digital PHY of claim 1, wherein the collision detector is arranged to report a collision if the buffer is not empty and no symbol is received by the PMA layer receiver in a predetermined time.

9. The Ethernet digital PHY of claim 1, wherein the size of the buffer is less than 10 symbols.

10. A method, comprising:
transmitting a signal comprising a plurality of symbols from a digital PHY to an Ethernet transceiver;
transmitting the signal back from the Ethernet transceiver to the digital PHY as received signals; and
signaling a collision when received symbols do not match transmitted symbols, or when bits of the received symbols do not match corresponding bits of the transmitted symbols.

11. The method of claim 10, comprising refraining from signaling the collision in response to a PCS collision enable line being de-asserted.

12. The method of claim 10, comprising
storing the plurality of symbols in a buffer;
comparing the received symbols or bits of the received symbols with symbols or bits in the buffer; and
remove matching symbols or bits from the buffer.

13. The method of claim 10, comprising signaling a collision in response to an energy detect (ED) input indicating a collision.

14. The method of claim 13, comprising refraining from signaling the collision in response to a PMA collision enable line being de-asserted.

15. The method of claim 13, further comprising signaling a collision in response to not receiving a symbol for a predetermined amount of time.

16. A collision detection system, comprising:
a buffer configured to store symbols transmitted to an Ethernet line;
a collision detector coupled to the buffer and configured to
compare symbols received from a transceiver to the symbols stored in the buffer; and
in response to the symbols received from the transceiver not matching the symbols stored in the buffer, signaling a collision,
wherein the collision detection system outputs a signal indicative of a collision based on the signaling of a collision output by the collision detector.

17. The collision detection system of claim 16, further comprising a first gate arrangement that outputs an intermediate signal indicative of a collision in response to the collision detector signaling a collision and a physical coding sublayer (PCS) collision enable line being asserted, wherein the collision detection system outputs the signal indicative of a collision based on the intermediate signal.

18. The collision detection system of claim 16, further comprising a second gate arrangement that outputs an intermediate signal indicative of a collision in response to an energy detect (ED) input indicating a collision and a physical medium attachment (PMA) collision enable line being asserted, wherein the collision detection system outputs the signal indicative of a collision based on the intermediate signal.

19. The collision detection system of claim 16, wherein the collision detector is configured to
compare a topmost symbol or topmost set of one bits in the buffer to a most recent received symbol or set of one or more bits,
remove each matching symbol or matching set of one or more bits from the buffer, and
signal a collision in response to the buffer becoming full.

20. The collision detection system of claim 16, wherein the collision detector is configured to signal a collision in response to not receiving a symbol in a predetermined time when the buffer is not empty.
